(19) United States
(12) Patent Application Publication
(10) Pub. No.: US 2019/0122313 A1
(43) Pub. Date: Apr. 25, 2019

(54) SYSTEM AND METHOD FOR CUSTOMIZED MEAL CREATION

(71) Applicant: SQUARE ROOTS KITCHEN, LLC., CHICAGO, IL (US)

(72) Inventors: Derin Alemli, Chicago, IL (US); Jason White, Chicago, IL (US); Conor McFerran, Chicago, IL (US)

(21) Appl. No.: 15/790,186

(22) Filed: Oct. 23, 2017

(51) Int. Cl. G06Q 50/12; G06Q 30/06

(52) U.S. Cl. CPC G06Q 50/12; G06Q 50/01; G06Q 30/0635

(57) ABSTRACT

A system and method for communication routing, and meal creation, based on an order for one or more items of a custom meal placed by a consumer, the method includes receiving, a dietary restriction communication from the consumer order placement application, the dietary restriction communication comprising at least one dietary restriction, determining a recommended ingredients list based on one or more dietary restrictions, displaying the recommended ingredients list to the consumer, receiving the recommended ingredients list as a function of the one or more selected ingredients and the one or more dietary restrictions received from the consumer order placement application, receiving a meal completion indication from the consumer order placement application, and transmitting the one or more ingredients from the consumer order placement application to a meal preparer usable to create the custom meal.

### BACKGROUND OF THE DISCLOSED EMBODIMENTS

Consumers are becoming more increasingly health conscious with respect to their outlook on diet and physical exercise. To that end, more and more consumers want both the ability to customize their food and for their customized food choices to fit within their dietary restrictions. Additionally, those consumers want to know the nutritional information (e.g., fats, sodium, calories, carbohydrates, etc.) of the foods prior to eating them. However, food menus typically offer a predetermined set of options that can be modified to a certain degree, such as adding or removing toppings and/or sides. Additionally, the menu typically displays only the caloric information of the food as prepared and shown in the menu. Accordingly, there exists a need for an improved computerized system and method for customized meal creation

### SUMMARY OF THE DISCLOSED EMBODIMENTS

The present application discloses a plurality of embodiments directed to computerized systems and method for customized meal creation.

In one embodiment, a method is provided for creating a customized meal, which may be executed by the consumer order placement application, or more particularly may be executed by the server of the consumer order placement application. The method includes determining whether to create a custom meal, such as may be initiated by a consumer approaching, launching, or otherwise initiating the action with the consumer order placement application; prompting the consumer to identify any dietary restrictions; prompting the consumer to identify whether they are adhering to eating requirements associated with a particular type of diet; alternatively prompting the consumer to identify whether they have any medical conditions that might impact their ability to eat certain foods.

In at least one embodiment, the consumer order placement application determines whether the consumer has entered any dietary restrictions.

In at least one embodiment the server identifies all ingredients from a master list of ingredients, such as may be stored in a master list in the ingredient database, which meet the dietary restrictions entered by the consumer. Additionally or alternatively, in some embodiments, the non-compliant ingredients may or may not be available for selection by the consumer.

In at least one embodiment, the server transmits via the communication router, to the consumer order placement application, the ingredients for selection by the consumer.

In at least one embodiment, the consumer order placement application displays a visual indicator of the present nutritional value(s) (i.e., nutritional information) for the meal. Such nutritional information may include, but is not limited to calories, fats, carbohydrates, proteins, sodium, fiber, etc.; determining whether any ingredients of the meal (i.e., meal ingredients) have changed (e.g., been added to or removed from the meal), such as may be initiated by a user selecting an associated graphical element displayed on the consumer order placement application; and determining any meal ingredients have changed.

In at least one embodiment, the server updates the nutritional information of the meal based on the changed meal ingredients as received from the consumer order placement application, via the communication router; updating a display on the consumer order placement application of the nutritional information associated with the meal ingredients; additionally or alternatively, updating one or more allocated nutrient value totals on the consumer order placement application; updating total of used/available macronutrients as a function of the selected meal ingredients.

In at least one embodiment, the server determines whether the meal creation has been completed, such as may be initiated by a user selecting an associated graphical element displayed on the consumer order placement application.

In at least one embodiment, the server determines the meal creation has been completed; completing any created meal purchase requirements, such as collecting payment, providing a receipt, obtaining a signature, etc.; transmitting the created meal to the appropriate meal preparer(s) in order to make the meal customized to order for the consumer.

In at least one embodiment, the server prompts the consumer to share, export, and/or save their created meal

In at least one embodiment, the server determines whether the consumer requested to share the customized meal they created using the consumer order placement application; prompting the consumer to select one or more social media outlets on which to share the customized meal; determining whether any social media outlets were selected; posting the customized meal to the selected social media outlet(s).

In at least one embodiment, the server determines whether the consumer requested to export the customized meal they created using the consumer order placement application to one or more food logging applications; prompting the consumer to select one or more food logging applications

In at least one embodiment, the server determines whether any food logging applications were selected; exporting the customized meal to the one or more selected food logging applications; additionally or alternatively, exporting information associated with the meal to the selected food logging applications by generating a barcode which is printable/scannable, such that the barcode can be used to import the information associated with the meal to the food logging applications selected for which such a method of information transmission is supported.

In at least one embodiment, the server determines whether the consumer requested to save the customized meal to their profile; saving the customized meal to the consumer profile; and allowing the consumer to associate certain information with the customized meal, such as a name, dietary restrictions associated with the customized meal, etc.

### BRIEF DESCRIPTION OF DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a simplified illustration of at least one embodiment of an environment of a consumer facing computing device for creating a customized meal;

FIG. 2 simplified block diagram of at least one embodiment of the consumer facing computing device of FIG. 1; and

FIGS. 3A-3D are a simplified flow diagram of at least one embodiment of a method for customizing a meal that may be executed by a custom meal creation management application of the consumer facing computing device of FIG. 1.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures, and/or procedures executed on a single computer or a network of computers. The software programs implemented by the system may be written in any programming language—interpreted, compiled, or otherwise. These languages may include, but are not limited to, VBA, LISP, embedded C, PHP, ASP.net, HTML, HTML5, Ruby, Perl, Java, Python, C++, C#, JavaScript, and/or the Go programming language. It should be appreciated, of course, that one of skill in the art will appreciate that other languages may be used instead, or in combination with the foregoing and that web and/or mobile application frameworks may also be used, such as, for example, Ruby on Rails, Node.js, Zend, Symfony, Revel, Django, Struts, Spring, Play, Jo, Twitter Bootstrap, and others. It should further be appreciated that the systems and methods disclosed herein may be delivered in a software-as-a-service (SaaS) model, made available over a computer network, such as, for example, the Internet. Further, the present disclosure may enable web services, application programming interfaces, and/or service-oriented architecture through one or more application programming interfaces (APIs) or other technologies.

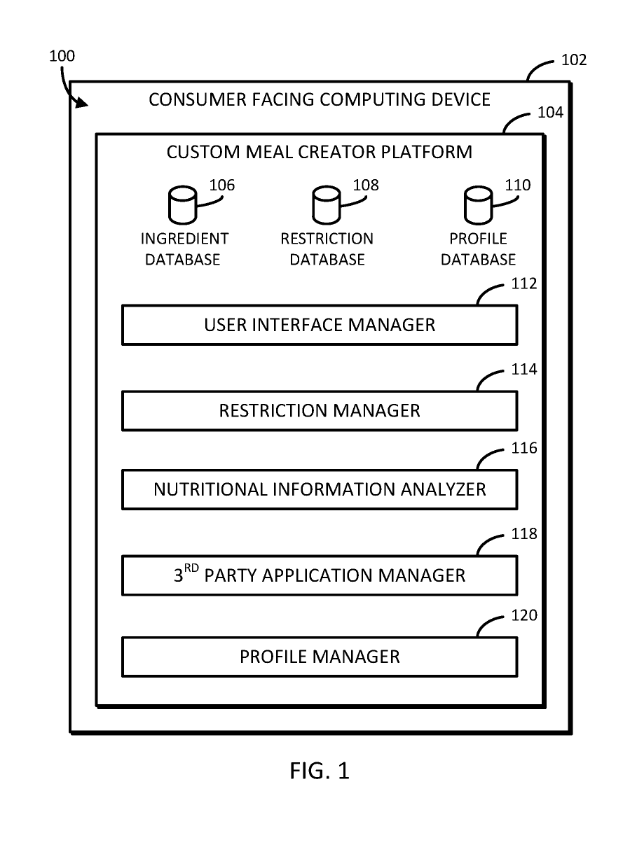

FIG. 1 is an illustrative system for creating a customized meal that includes a consumer order placement application 102. In use, a consumer interfaces with the consumer order placement application 102, or more particularly the consumer interfaces with an executing instance of a server 104, to create a customized meal. To do so, unlike present technologies, the server 104 is configured to first retrieve any dietary restrictions from the consumer. As will be described in further detail below, the dietary restrictions may include any food allergies of the consumer, a type of diet the consumer is associated with, a medical condition of the consumer, etc. Upon receiving an indication of any dietary restrictions, the server 104 is configured to update a menu of ingredients to reflect the selected dietary restrictions. It should be appreciated that the term “ingredients” as used herein describes a base, a protein, a topping, a sauce, a side, a drink, etc., as opposed to individual substances (e.g., flour, sugar, salt, etc.) used to form a mixture to prepare a dish. However, it should be appreciated that some individual substances may also be selected as a toppings.

In an illustrative embodiment, the server 104 is configured to only show those ingredients that are aligned with the dietary restrictions, via consumer order placement application 102. For example, if the consumer indicates that they are following the Paleo diet, the server 104 may be configured to hide those ingredients which are not compliant with the Paleo diet (e.g., grain-based products such as bread, pasta, tortillas, etc.). Alternatively, in other embodiments, the server 104 may be configured to provide a visual indication (e.g., greyscale images, a red/yellow/green light indicator, etc.) that such ingredients are not consistent with the dietary restrictions selected by the consumer.

The server 104 is additionally configured to provide a visual indication, via consumer order placement application 102, of the nutritional value of the meal as ingredients are added and removed. The nutritional value may include any nutritional value usable to identify whether the consumer is comfortable adding the ingredient to their meal, such as calories, fats, carbohydrates, proteins, sodium, fiber, etc. In some embodiments, the server 104 may be further configured to provide the same or similar visual indications of the individual ingredients themselves. It should be appreciated that the visual indication may include a graphical representation and/or a textual/numeric representation of the nutritional information.

The illustrative server 104 includes an ingredient database 106, a restriction database 108, and a profile database 110. The ingredient database 106 is configured to store available ingredients and their corresponding nutritional values. The restriction database 108 is configured to store a list of dietary restrictions (e.g., foods commonly associated with allergies, types of diets, medical conditions associated with certain foods, etc.) and the ingredients associated therewith. The profile database 110 is configured to store profile information for each consumer, such as consumer identifiers (e.g., image, name, email address, telephone number, address, etc.), profile access credentials, previously stored dietary restrictions, previously stored meals, linked social media accounts, linked food loggers, images of meals, etc.

While the ingredient database 106, the restriction database 108, and the profile database 110 are illustratively shown as residing on the server 104, it should be appreciated that, in some embodiments, one or more of the ingredient database 106, the restriction database 108, and the profile database 110 may be located remote of the server 104 (i.e., on one or more different computing devices, such as a storage server). It should be further appreciated that, in some embodiments, the data stored in the respective databases may not be mutually exclusive. In other words, certain data described herein as being stored in one database may additionally or alternatively be stored in another database described herein, or another database altogether. It should be further appreciated that, in some embodiments, the data may be stored in a single database, or an alternative database/data storage arrangement.

The illustrative server 104 additionally includes a user interface manager 112, a restriction manager 114, a nutritional information analyzer 116, a third party application manager 118, and a profile manager 120, each of which may be embodied as any type of firmware, hardware, software, circuitry, or combination thereof that is configured to perform the functions described herein. It should be appreciated that, while certain functions of the server 104 are described herein as being performed by independently operable components, one or more of the functions may be performed by additional or alternative components and/or alternative component arrangements, in other embodiments.

The user interface manager 112 is configured to interface with the consumer. To do so, the user interface manager 112 is configured to render (i.e., to a display of the consumer order placement application 102) one or more user interface elements (e.g., graphical user interface (GUI) elements, HyperText Markup Language (HTML) images/objects, etc.) usable by the consumer to identify ingredients, visually interpret nutritional information, view their meal, make a payment, etc.

The restriction manager 114 is configured to manage the dietary restrictions and the ingredients associated therewith. In other words, the restriction manager 114 is configured to receive none, one, or more dietary restrictions from the consumer and identify those ingredients which are affected by the dietary restrictions. For example, if the consumer identified themselves as a diabetic, the restriction manager 114 is configured to identify those ingredients which should not be eaten by the consumer based on their identifying themselves a diabetic, such as sugary foods, fruit juice beverages, coffee, deep-fried foods, processed grains, etc. The restriction manager 114 may be configured to identify those ingredients by placing an indication in a corresponding table entry of a database that indicates whether the food is advised or not based on the identified dietary restriction(s), as applicable.

The nutritional information analyzer 116 is configured to analyze the nutritional information associated with the food and update the data usable to generate the visual representations of the meal/ingredient nutritional information. To do so, the nutritional information analyzer 116 may be configured to perform a mathematical computation on the nutritional ingredients selected for the meal at any given time. For example, one such visual representation may be usable to indicate a total number of calories, carbohydrates, protein, and fat associated with a customized meal at any given time during its creation.

The third party application manager 118 is configured to manage the communications between the server 104 and various third party applications. In some embodiments, the third party applications, such as Facebook®, LinkedIn®, Twitter®, Instagram®, MyFitnessPal®, LoseIt!, etc., may be linked to a profile of the consumer such that the third party application manager 118 can use an application programming interface (API) associated with the respective third party application to send communications. Additionally or alternatively, in some embodiments, the third party applications may not be linked, but the third party application manager 118 may be configured to generate an output (e.g., a barcode, a comma delimited list, etc.) that is usable by the respective third party application to interpret the output such that information from the server 104 can be shared, exported, etc.

The profile manager 120 is configured to manage profiles of the consumers registered with the server 104. To do so, the profile manager 120 is configured to interface with a consumer to retrieve information to store in the respective profile (e.g., within the profile database 110). The profiles may include consumer information (e.g., image, name, email address, telephone number, address, etc.), profile access credentials, dietary restrictions, previously customized meals, linked social media accounts, linked food loggers, images of previously customized meals, etc.

It should be appreciated that, while the server 104 is illustratively shown as a separate portion from the consumer order placement application 102, the server 104, or at least a portion of the functions thereof as described herein, may be performed as a unitary device. In illustrative example, the server 104, or at least a portion of the functions thereof as described herein, may be executed on one or more remote servers such that the consumer order placement application 102 includes an interface (not shown) which may be embodied as a type of network-based software application (e.g., thin/zero client, cloud application, network application, software-as-a-service (SaaS) application, etc.) configured to communicate with the server 104 via a communication router 130.

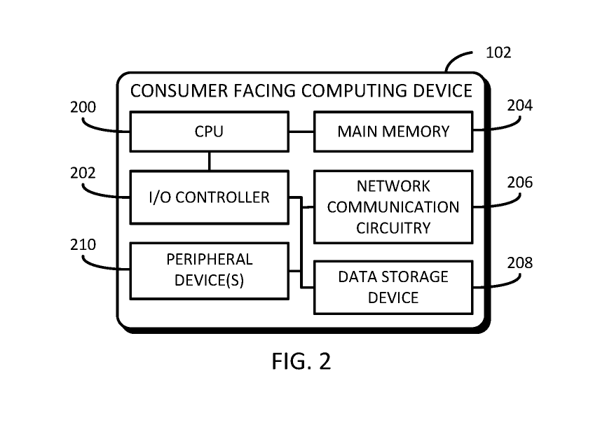

The consumer order placement application 102 may be embodied as any type of computing device capable of performing the functions described herein, including, but not limited to, a desktop computer, a kiosk, a mobile computing device (e.g., a smartphone, a wearable, a tablet, a laptop, a notebook, etc.), etc. Referring now to FIG. 2, an illustrative device 200 featuring consumer order placement application 102 includes a central processing unit (CPU) 212, an input/output (I/O) controller 202, a main memory 204, network communication circuitry 206, a data storage device 208, and one or more I/O peripheral devices 210.

In some alternative embodiments, the device 200 featuring consumer order placement application 102 may include additional, fewer, and/or alternative components to those of the illustrative consumer order placement application 102, such as a graphics processing unit (GPU). It should be appreciated that one or more of the illustrative components may be combined on a single system-on-a-chip (SoC) on a single integrated circuit (IC). Additionally, it should be appreciated that the type of components and/or hardware/software resources of the consumer order placement application 102 may be predicated upon the type and intended use of the consumer order placement application 102.

The CPU 212, or processor, may be embodied as any combination of hardware and circuitry capable of processing data. In some embodiments, the consumer order placement application 102 may include more than one CPU 212. Depending on the embodiment, the CPU 212 may include one processing core (not shown), such as in a single-core processor architecture, or multiple processing cores, such as in a multi-core processor architecture. Irrespective of the number of processing cores and CPUs 212, the CPU 212 is capable of reading and executing program instructions. In some embodiments, the CPU 212 may include cache memory (not shown) that may be integrated directly with the CPU 212 or placed on a separate chip with a separate interconnect to the CPU 212. It should be appreciated that, in some embodiments, pipeline logic may be used to perform software and/or hardware operations (e.g., network traffic processing operations), rather than commands issued to/from the CPU 212.

The I/O controller 202, or I/O interface, may be embodied as any type of computer hardware or combination of circuitry capable of interfacing between input/output devices and the consumer order placement application 102. Illustratively, the I/O controller 202 is configured to receive input/output requests from the CPU 212, and send control signals to the respective input/output devices, thereby managing the data flow to/from the consumer order placement application 102.

The memory 204 may be embodied as any type of computer hardware or combination of circuitry capable of holding data and instructions for processing. Such memory 204 may be referred to as main or primary memory. It should be appreciated that, in some embodiments, one or more components of the consumer order placement application 102 may have direct access to memory, such that certain data may be stored via direct memory access (DMA) independently of the CPU 212.

The network communication circuitry 206 may be embodied as any type of computer hardware or combination of circuitry capable of managing network interfacing communications (e.g., messages, datagrams, packets, etc.) via wireless and/or wired communication modes. Accordingly, in some embodiments, the network communication circuitry 206 may include a network interface controller (NIC) capable of being configured to connect the consumer order placement application 102 to a computer network, as well as other devices, depending on the embodiment.

The data storage device 208 may be embodied as any type of computer hardware capable of the non-volatile storage of data (e.g., semiconductor storage media, magnetic storage media, optical storage media, etc.). Such data storage devices 208 are commonly referred to as auxiliary or secondary storage, and are typically used to store a large amount of data relative to the memory 204 described above.

Each of the I/O peripherals 210 may be embodied as any type of auxiliary device configured to connect to and communicate with the consumer order placement application 102. Depending on the embodiment, the one or more I/O peripherals 210 may include, but are not limited to those I/O peripherals commonly associated with telephone or video calls, such as, a camera 212, a display 212, a microphone 214, a speaker 216, etc. However, it should be appreciated that the I/O peripherals 210 may include additional and/or alternative I/O devices, such as, but not limited to, a mouse, a keyboard, a touchscreen, a printer, a scanner, etc. Accordingly, it should be appreciated that some I/O devices are capable of one function (i.e., input or output), or both functions (i.e., input and output).

In some embodiments, the I/O peripherals 210 may be connected to the consumer order placement application 102 via a cable (e.g., a ribbon cable, a wire, a universal serial bus (USB) cable, a high-definition multimedia interface (HDMI) cable, etc.) connected to a corresponding port (not shown) of the consumer order placement application 102 through which the communications made there between can be managed by the I/O controller 202. In alternative embodiments, the I/O peripherals 210 may be connected to the consumer order placement application 102 via a wireless mode of communication (e.g., Bluetooth®, Wi-Fi®, etc.) which may be managed by the network communication circuitry 206.

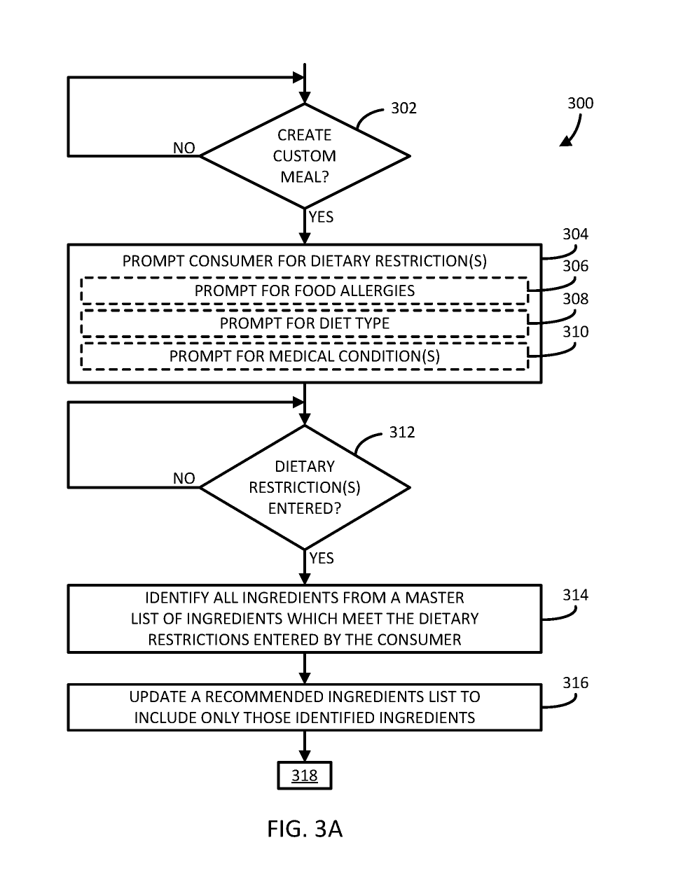

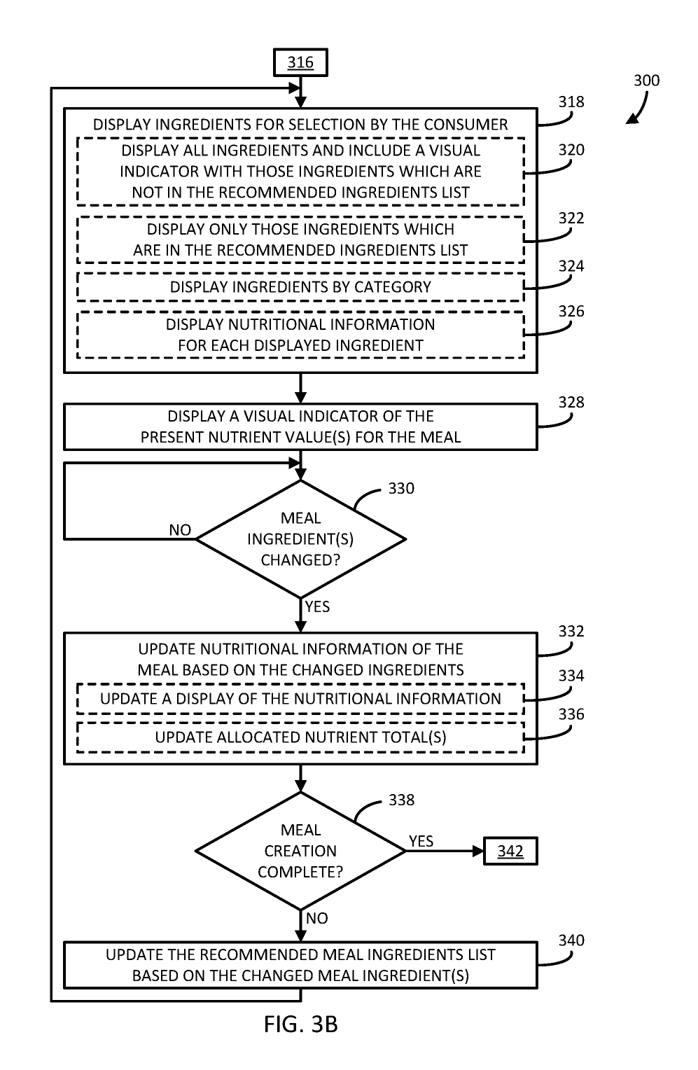

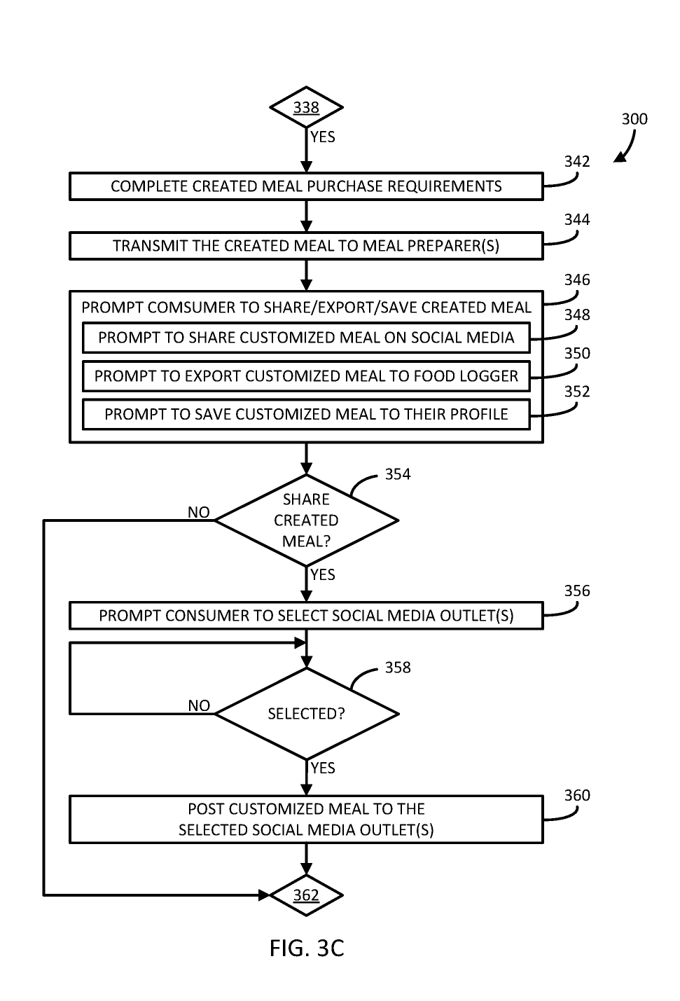

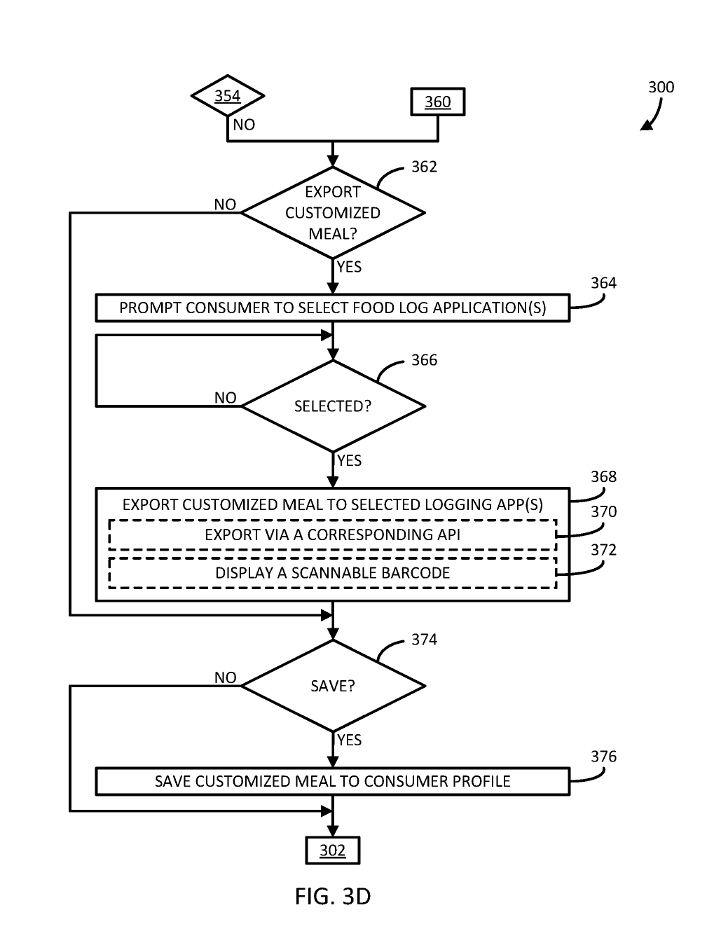

Referring now to FIGS. 3A-3D, an illustrative method 300 is provided for creating a customized meal, which may be executed by the consumer order placement application 102, or more particularly may be executed by the server 104 of the consumer order placement application 102. The method 300 begins in block 302, in which the server 104 determines whether to create a custom meal, such as may be initiated by a consumer approaching, launching, or otherwise initiating the action with the consumer order placement application 102. In block 304, the consumer order placement application 102 prompts the consumer to identify any dietary restrictions. For example, in block 306, the consumer order placement application 102 may prompt the consumer to identify whether they have any food allergies. Additionally or alternatively, in block 308, the consumer order placement application 102 may prompt the consumer to identify whether they are adhering to eating requirements associated with a particular type of diet. In block 310, the consumer order placement application 102 may additionally or alternatively prompt the consumer to identify whether they have any medical conditions that might impact their ability to eat certain foods.

In block 312, the server 104 determines whether the consumer has entered any dietary restrictions. It should be appreciated that the consumer may have entered none, one, or more than one dietary restriction. In block 314, the server 104 identifies all ingredients from a master list of ingredients, such as may be stored in a master list in the ingredient database 106, which meet the dietary restrictions entered by the consumer. In other words the server 104 filters out those ingredients which are not in compliance with the dietary restrictions, such that only those ingredients which meet the dietary restrictions entered by the consumer are available for selection. In some embodiments, a visual indicator may be used to identify those elements which are and/or are not in compliance with the dietary restrictions. Additionally or alternatively, in some embodiments, the non-compliant ingredients may or may not be available for selection by the consumer. In block 316, the server 104 updates a recommended ingredients list to include only those ingredients identified in block 314.

In block 318, shown in FIG. 3B, the server 104 transmits via the communication router 130, to the consumer order placement application 102, the ingredients for selection by the consumer. Optionally, in block 320, in some embodiments, the consumer order placement application 102 may display all ingredients (i.e., all ingredients of the master list of ingredients) and include a visual indicator identifying those ingredients which are not in the recommended ingredients list, as received from the server 104 via the communication router 130. Alternatively, in block 322, the consumer order placement application 102 may display only those ingredients which are in the recommended ingredients list (i.e., hide the ingredients which are not in the recommended ingredients list). In block 324, the consumer order placement application 102 may display the recommended ingredients by category (e.g., base, proteins, toppings, sides, drinks, etc.). In block 326, the consumer order placement application 102 may display nutritional information for each of the displayed ingredients.

In block 328, the consumer order placement application 102 displays a visual indicator of the present nutritional value(s) (i.e., nutritional information) for the meal. Such nutritional information may include, but is not limited to calories, fats, carbohydrates, proteins, sodium, fiber, etc. In block 330, the server 104 determines whether any ingredients of the meal (i.e., meal ingredients) have changed (e.g., been added to or removed from the meal), such as may be initiated by a user selecting an associated graphical element displayed on the consumer order placement application 102. It should be appreciated that the user may complete the meal if all ingredient changes have been made. In other words, the user may initiate completion of the meal creation, in which the method 300 would branch to block 342, which is described below. If the server 104 determines any meal ingredients have changed (i.e., added, removed, quantity/size updated, etc.), the method 300 advances to block 332.

In block 332, the server 104 updates the nutritional information of the meal based on the changed meal ingredients as received from the consumer order placement application 102, via the communication router 130. To do so, in block 334, the server 104 may update a display on the consumer order placement application 102 of the nutritional information associated with the meal ingredients (e.g., a nutrient value total for each respective nutritional value, such as a total amount of fats, a total amount of carbohydrates, a total amount of protein, a total amount of sodium, a total amount of fiber, etc.). Additionally or alternatively, in block 336, the server 104 may update one or more allocated nutrient value totals on the consumer order placement application 102. Such allocated nutrient value totals may be associated with a particular diet, for example, such as one in which macronutrients are tracked. In an illustrative example, a consumer may have entered (e.g., in block 312) that they count their macronutrients for each meal. Additionally, that consumer may have input a predetermined number of carbohydrates, fats, and proteins they have allocated for that particular meal. As such, the server 104 may show via the consumer order placement application 102, an updated total of used/available macronutrients as a function of the selected meal ingredients.

In block 338, the server 104 determines whether the meal creation has been completed, such as may be initiated by a user selecting an associated graphical element displayed on the consumer order placement application 102. If not, the method 300 branches to block 340 in which the server 104 updates the recommended meal ingredients list, and thereby any visual indicators associated therewith, based on the changed meal ingredients. In an illustrative example, a consumer may have entered (e.g., in block 308) that they adhere to a low carb diet. As such, the server 104 may be configured to compare the present carb total of the meal ingredients against a predetermined threshold (e.g., auto-generated, dynamic per consumer, based on user input, etc.) to determine whether a recommendation associated with any available ingredients were affected by the change. Of course, it should be appreciated that, under certain dietary restrictions, the addition/removal/change of meal ingredients may not have any impact on the list of recommended meal ingredients.

Referring back to block 338, if the server 104 determines the meal creation has been completed, the method 300 branches to block 342, shown in FIG. 3C. In block 342, the server 104 completes any created meal purchase requirements, such as collecting payment, providing a receipt, obtaining a signature, etc. In block 344, the server 104 transmits the created meal to the appropriate meal preparer(s) in order to make the meal customized to order for the consumer.

In block 346, the server 104, via the consumer order placement application 102, prompts the consumer to share, export, and/or save their created meal. For example, in block 348, the server 104 prompts the user to share their customized meal to social media. In another example, in block 350, the server 104 prompts the user to export their customized meal to a food logger, also commonly referred to as a food tracker. In still another example, in block 352, the server 104 prompts the user to save their customized meal to their consumer profile.

In block 354, the server 104 determines whether the consumer requested to share the customized meal they created using the consumer order placement application 102 to one or more social media outlets. If not, the method 300 branches to block 362 described below; otherwise, the method 302 advances to block 356, in which the server 104 prompts the consumer to select one or more social media outlets on which to share the customized meal. It should be appreciated that the consumer may have previously linked one or more social media accounts to their profile, or may be prompted to do so at this time. In block 358, the server 104 determines whether any social media outlets were selected. If so, the method 300 advances to block 360, in which the server 104 posts the customized meal (e.g., ingredient list, nutritional values, etc.) to the selected social media outlet(s).

In block 362, the server 104 determines whether the consumer requested to export the customized meal they created using the consumer order placement application 102 to one or more food logging applications. If not, the method 300 branches to block 374 described below; otherwise, the method 300 advances to block 364, in which the server 104 prompts the consumer to select one or more food logging applications. It should be appreciated that the consumer may have previously linked one or more food logging application accounts to their profile, or may be prompted to do so at this time.

In block 366, the server 104 determines whether any food logging applications were selected in consumer order placement application 102. If so, the method 300 advances to block 368, in which the server 104 exports the customized meal to the one or more selected food logging applications. To do so, in block 370, in some embodiments, the server 104 may export information associated with the meal (e.g., the total nutritional values and/or the corresponding nutritional values for each ingredient) to the selected food logging applications using an API associated with each respective food logging application selected for which such a method of information transmission is supported. Additionally or alternatively, the server 104 may export information associated with the meal (e.g., the total nutritional values, the corresponding nutritional values for each ingredient, serving size, number of servings, etc.) to the selected food logging applications by generating a barcode which is printable/scannable, such that the barcode can be used to import the information associated with the meal to the food logging applications selected for which such a method of information transmission is supported.

In block 374, the server 104 determines whether the consumer requested to save the customized meal to their profile, via consumer order placement application 102. It should be appreciated that the consumer may have previously created their profile, or may be prompted to do so at this time. If the consumer has not requested that their customized meal is saved to their profile, the method 300 returns to block 302 to determine whether another meal has been requested for customization. Otherwise, if the consumer has requested that their customized meal be saved to their profile, the method 300 advances to block 376, in which the server 104 saves the customized meal to the consumer profile. It should be appreciated that the saved customized meal may then be recalled by the consumer at a later date. In some embodiments, the server 104 may allow the consumer to associate certain information with the customized meal, such as a name, dietary restrictions associated with the customized meal, etc.

In at least one embodiment of the present disclosure, the server 104 may be configured to integrate with third-party food ordering platforms (e.g. GrubHub). It will be appreciated that an order placed via the consumer order placement application 102 may be transmitted to third-party food ordering platforms, whereby food orders are placed and originate at the server 104. It will be further appreciated that such order information may be exchanged with third-party platforms via custom APIs, and the like.

While the present disclosure has been illustrated and described in detail in the drawings and foregoing description, the same is to be considered as illustrative and not restrictive in character, it being understood that only certain embodiments have been shown and described, and that all changes and modifications that come within the spirit of the present disclosure are desired to be protected.

What is claimed is:

1. A method for transmitting an instruction communication from a server including a communication router coupled to a communication network, for preparation of a custom meal placed through a consumer order placement application in communication with the server, the instruction communication being based upon information received from the consumer order placement application, and a restriction application, the method comprising the steps of:
receiving, at the server, an order communication from the consumer order placement application, the order communication comprising an order for one or more items of a custom meal placed by a consumer;
receiving, at the server, a dietary restriction communication from the consumer order placement application, the dietary restriction communication comprising at least one dietary restriction;
determining, at the server, a recommended ingredients list based on one or more dietary restrictions received from the consumer order placement application;
displaying, via the consumer order placement application, the recommended ingredients list to the consumer;
receiving, at the server, the recommended ingredients list as a function of the one or more selected ingredients and the one or more dietary restrictions received from the consumer order placement application;
receiving, at the server, a meal completion indication from the consumer order placement application; and
transmitting, by the server via the communication router, the one or more ingredients from the consumer order placement application to a meal preparer to create the custom meal.

2. The method of claim 1, wherein the one or more dietary restrictions include at least one of a food allergy, a type of diet, or a medical condition.

3. The method of claim 1, wherein determining the recommended ingredients list comprises determining, from a master ingredients list, the recommended ingredients list to include only the ingredients which are in compliance with the one or more dietary restrictions received from the consumer order placement application.

4. The method of claim 1, further comprising:
determining, at the server, one or more present nutrient values for each of the one or more ingredients selected by the consumer;
transmitting, via the communication router, the one or more present nutrient values to the consumer order placement application; and
displaying, by the consumer order placement application, the one or more present nutrient values for each of the one or more ingredients.

5. The method of claim 4, wherein displaying the one or more present nutrient values for each of the one or more ingredients comprises displaying a visual indication comprised of a graphic and text usable to identify the one or more present nutrient values, at the consumer order placement application.

6. The method of claim 4, wherein the one or more present nutrient values include at least one of a calorie amount, a fat amount, a carbohydrate amount, a protein amount, a sodium amount, or a fiber amount.

7. The method of claim 1, wherein displaying the recommended ingredients list at the consumer order placement application comprises displaying a visual indicator with each ingredient, and wherein the visual indicator is usable to identify whether the ingredient is in compliance with the one or more dietary restrictions received from the consumer order placement application.

8. The method of claim 1, wherein displaying the recommended ingredients list at the consumer order placement application comprises displaying only the recommended ingredients list.

9. The method of claim 1, wherein displaying the recommended ingredients list at the consumer order placement application comprises displaying the recommended ingredients list by a corresponding category, and wherein the corresponding category comprises one of a base, a protein, a topping, a sauce, a side, or a drink.

10. The method of claim 1, further comprising:
prompting, by the consumer order placement application, the consumer to share the created meal via an account corresponding to a social media application, wherein the account is associated with the consumer; and
sharing, by the consumer order placement application and in response to having received an indication that the consumer has requested to share the created meal, the created meal to the social media account.

11. The method of claim 1, further comprising:
prompting, by the consumer order placement application, the consumer to save the created meal to a profile associated with the consumer; and
saving, by the consumer order placement application and in response to having received an indication that the consumer has requested to save the created meal to the profile associated with the consumer, the created meal to the profile associated with the consumer.

12. The method of claim 1, further comprising:
prompting, by the consumer order placement application, the consumer to export the created meal via an account corresponding to a food logging application, wherein the account is associated with the consumer; and
sharing, by the consumer order placement application and in response to having received an indication that the consumer has requested to export the created meal, the created meal to the requested account.

13. A computerized system coupled to a communication network, the system operative for transmitting of an order to a meal preparer, the system comprising:
a consumer order placement application;
a server for receiving a dietary restriction communication form the consumer order placement application over the communication network, the dietary restriction communication comprising at least one dietary restriction;
the server further configured to receive an order for one or more items from the consumer order placement application, the order placed by a consumer;
a database of item information comprising available ingredients and their corresponding nutritional values;
the database further comprising a list of dietary restrictions and ingredients associated therewith, and a recommended ingredients list based on one or more dietary restrictions;
wherein the server identifies a recommended ingredients list based on one or more dietary restrictions received from the consumer order placement application;
wherein the server receives one or more ingredients from the consumer order placement application, the one or more ingredients selected by the consumer for creation of a custom meal;
wherein the server is operative to transmit, by the communication router over the communication network to a meal preparer, an instruction communication to begin preparation of each of the one or more items of the custom meal, so that each of the one or more items of the custom meal substantially conforms to the dietary restrictions of the consumer.

14. The system of claim 13, wherein the one or more dietary restrictions include at least one of a food allergy, a type of diet, or a medical condition.

15. The system of claim 13, wherein the server is operative to determine, from a master ingredients list, the recommended ingredients list to include only the ingredients which are in compliance with the one or more dietary restrictions received from the consumer order placement application.

16. The system of claim 13, further comprising:
determining, at the server, one or more present nutrient values for each of the one or more ingredients selected by the consumer;
transmitting, via the communication router, the one or more present nutrient values to the consumer order placement application; and
displaying, by the consumer order placement application, the one or more present nutrient values for each of the one or more ingredients.

17. The system of claim 16, wherein the one or more present nutrient values include at least one of a calorie amount, a fat amount, a carbohydrate amount, a protein amount, a sodium amount, or a fiber amount.

18. The system of claim 13, wherein displaying the recommended ingredients list at the consumer order placement application comprises displaying a visual indicator with each ingredient, and wherein the visual indicator is usable to identify whether the ingredient is in compliance with the one or more dietary restrictions received from the consumer order placement application.

19. The system of claim 13, wherein displaying the recommended ingredients list at the consumer order placement application comprises displaying only the recommended ingredients list.

20. The system of claim 13, wherein displaying the recommended ingredients list at the consumer order placement application comprises displaying the recommended ingredients list by a corresponding category, and wherein the corresponding category comprises one of a base, a protein, a topping, a sauce, a side, or a drink.

21. The system of claim 13, where the consumer order placement application, is further configured to share the created meal via an account corresponding to a social media application, wherein the account is associated with the consumer; and
wherein the consumer order placement application is configured to share in response to having received an indication that the consumer has requested to share the created meal, the created meal to the social media account.

22. The system of claim 13, wherein the consumer order placement application is configured to save the created meal to a profile associated with the consumer, and configured to save in response to having received an indication that the consumer has requested to save the created meal to the profile associated with the consumer, the created meal to the profile associated with the consumer.

23. The system of claim 13, wherein the consumer order placement application is configured to export the created meal via an account corresponding to a food logging application, wherein the account is associated with the consumer, and configured to share in response to having received an indication that the consumer has requested to export the created meal, the created meal to the requested account.
